(19) United States
(12) Patent Application Publication
(10) Pub. No.: US 2021/0388673 A1
(43) Pub. Date: Dec. 16, 2021

(54) Roller Blind Assembly with Improved Light Absorption or Light Reflection

(71) Applicant: Lafayette Venetian Blind, Inc., West Lafayette, IN (US)

(72) Inventors: Joe Nash Morgan, III, West Lafayette, IN (US); Adam Vandewalle, Lafayette, IN (US)

(21) Appl. No.: 16/898,497

(22) Filed: Jun. 11, 2020

(51) Int. Cl. E06B 9/42

(52) U.S. Cl. CPC E06B 9/42; E06B 2009/2417

(57) ABSTRACT

A blind assembly, a roller, and a method of assembling the same that reduces deviations from planarity (i.e. ripples and waves) and shadows on the surface of the fabric by utilizing fabric connected to at least one strip with no shape memory.

### FIELD

This disclosure is related to a zebra type roller blind assembly comprised of a strip, frame and roller, wherein the strip is straight enough to reduce fabric shadowing or wherein the strip does not have shape memory, and a method of attaching a fabric to a strip of such a blind assembly.

### BACKGROUND

Zebra Shades are an alternative to a horizontal blind. Also referred to as a Layered, Dual, or Banded Shade, this window treatment offers the light control of a blind and the soft beauty of a fabric roller shade. Zebra shades feature a combination of sheer and solid fabrics in a single shade. Zebra Shades are Roller shades that allow the user to transition between sheer and privacy. Much like opening and closing the slats of a blind, Zebra Shades control light by alternating the bands from open to close. Zebra shades can be adjusted so that the zebra stripes line up-offering privacy, light control, and insulation. The user can also adjust the zebra blinds slightly, aligning the sheer fabric sections to allow incoming daylight. Zebra shades allow the user to adjust the natural light levels by simply pulling the chain. Unlike Roller Shades they can be cracked slightly only allowing very little light into the room. Zebra Shades may be operated through motorization and cordless options or operated by a side chain that allows the user to maneuver the shade so the user can see through the stripes or the user can retract the blind entirely allowing the user to see out completely.

The second end of the fabric may be attached to either the frame of the blind assembly or to an accessory such as a strip which is located within the blind assembly.

A strip may experience shape memory if the strip is wound on a spool. The strip may have been rolled up on the spool during manufacturing, as part of storage, packaging or shipping. For example, a typical strip is Rollease HBIS External Hem Bar Adhesive Strip HBIS 300 ft. Roll available at http://www.designersworkroomsupplies.com/rollease-hbis-external-hem-bar-adhesive-strip-hbis-300-ft-roll/illustrated in FIG. 1B. Another typical strip is ZMC Window Covering Supplies Hem Bar Strip 40′/roll available at https://www.zmc.ca/products/somfy/side-channel-accessories/hem-bar-strip-40-roll/illustrated in FIG. 1C.

As an example, after the strip is removed from the spool, the straightened strip retains shape memory. If the straightened strip is placed in a void of a frame of a blind assembly, the strip will not remain straight enough to minimize fabric shadowing. It is envisioned that the user may be able to unwind the strip and use force or energy to minimize the shape memory.

A problem with any shade assembly with sheer or thin fabric wherein the second end of the fabric is attached to a biased strip, is that the fabric may ripple, wrinkle and/or undulate. Stated another way, the shape memory in the strip attached to the fabric may result in shadows and shadow ripples. Shadows and rippling cascade and increase in size as they progress down the shade.

Another problem with any shade assembly wherein the second end of the fabric is attached to a biased strip, is that the fabric may ripple, wrinkle and/or undulate. Stated another way, the shape memory in the strip attached to the fabric may result in shadows and shadow ripples. Shadows and rippling cascade and increase in size as the size of the shade assembly and the corresponding fabric increase such as for a 90″ wide shade.

Another problem with any shade assembly with room darkening fabric wherein the second end of the fabric is attached to a biased strip, is that the fabric may ripple, wrinkle and/or undulate. Stated another way, the shape memory in the strip attached to the fabric may result in shadows and shadow ripples. Shadows and rippling cascade and increase in size which negatively affects light absorption or light reflection.

FIG. 1 of U.S. Pat. No. 9,957,751 discloses a prior art blind assembly 101 as a rollable blind assembly, including a winding core 2 and a shade material 3 suspended therefrom. In the embodiment of FIG. 1, the shade material 3 is attached to the winding core 2 in a conventional manner. The shade material 3 is seen to feature ripples 30 when the winding core 2 sags (which in FIG. 1 has been depicted in exaggerated form).

As discussed in U.S. Pat. No. 9,957,751 regarding a similar problem of sag of the fabric caused by sag in the winding core 2 (as best illustrated in FIG. 5 of the 751 U.S. patent), the unwanted shadows and shadow ripples negatively impact the view quality for the user. The shadows and ripples may indicate a defective blind assembly to a user. The shadows and ripples may hinder incoming daylight, as well as negatively impact the user's view of outside. Ripples distort the amount of light absorption or light reflection by the fabric by modifying the amount of fabric any particular light ray has to traverse through the fabric.

### SUMMARY

The present disclosure aims to provide an improved shade assembly with reduced shadows and shadow ripples by utilizing a strip that is straight enough to reduce fabric shadowing, a strip comprised of materials with straight shape memory, a strip comprised of materials with substantially no shape memory or a strip with no non-straight shape memory.

In one aspect of the disclosure, a blind assembly is disclosed comprising a frame, a roller supported by the frame, a fabric suspended from the roller, a strip located within the frame and wherein an end of the fabric is attached to the strip, wherein the strip is comprised of materials with straight shape memory, the strip is comprised of materials with substantially no shape memory, the strip is straight enough to reduce fabric shadowing or wherein the strip does not have non-straight shape memory.

In another aspect of the disclosure, a method of assembling a blind assembly is disclosed comprising the steps of (i) attaching an end of the fabric to the strip, and (ii) inserting the strip with attached fabric into the frame, wherein the strip is straight enough to reduce fabric shadowing or wherein the strip does not have shape memory.

### BRIEF DESCRIPTION OF THE DRAWINGS

The above-mentioned and other features of this disclosure, and the manner of attaining them, will become more apparent and the disclosure itself will be better understood by reference to the following description of embodiments of the disclosure taken in conjunction with the accompanying drawings, wherein:

Unless otherwise stated, a reference to a compound or component includes the compound or component by itself, as well as in combination with other compounds or components, such as mixtures of compounds.

As used herein, the singular forms “a”, “an” and “the” include the plural reference unless the context clearly dictates otherwise.

All publications, patents and patent applications cited herein, whether supra or infra, are hereby incorporated by reference in their entirety to the same extent as if each individual publication, patent or patent application was specifically and individually indicated to be incorporated by reference.

FIG. 1A is a perspective view of the back of a typical zebra type roller blind shade.

FIG. 1B is a perspective view of a typical strip on a spool.

FIG. 1C is a perspective view of a typical strip on a spool.

FIG. 2 is a perspective view of the back of a typical zebra type roller blind shade.

FIG. 3 is a perspective view of the back of the zebra type roller blind shade according to an embodiment of the present disclosure.

FIG. 4 is a perspective view of the back of the zebra type roller blind shade of FIG. 3.

FIG. 5A is an individual strip used in the shade assembly according to an embodiment of the present disclosure.

FIG. 5B is a perspective view of a series of connected individual strips used in the shade assembly according to an embodiment of the present disclosure.

FIG. 6A is a perspective view of a couple of strips used in the shade assembly according to an embodiment of the present disclosure.

FIG. 6B is a perspective view of an individual strip used in the shade assembly according to an embodiment of the present disclosure.

FIG. 6C is a perspective view of another individual strip used in the shade assembly according to an embodiment of the present disclosure wherein the individual strip is long enough to cover the width of the fabric or frame.

FIG. 6D is a perspective view of the individual strips of FIGS. 6B and 6C according to an embodiment of the present disclosure.

FIG. 7 is a perspective view of the zebra type roller blind shade assembly according to an embodiment of the present disclosure.

FIG. 8 is a perspective view of the zebra type roller blind shade assembly according to an embodiment of the present disclosure.

FIG. 9 is a perspective view of the LED arrangement of the Experimental Results.

FIG. 10 is a perspective view of the zebra type roller blind shade assembly with Mirage Ice according to an embodiment of the present disclosure.

FIG. 11 is a perspective view of the zebra type roller blind shade assembly with Mystic Canyon according to an embodiment of the present disclosure.

FIG. 12 is a perspective view of the zebra type roller blind shade assembly with Covert Flannel according to an embodiment of the present disclosure.

Corresponding reference characters indicate corresponding parts throughout the several views. Although the drawings represent embodiments of the present disclosure, the drawings are not necessarily to scale and certain features may be exaggerated in order to better illustrate and explain the present disclosure.

### DETAILED DESCRIPTION OF THE EXEMPLARY EMBODIMENTS

The embodiments disclosed below are not intended to be exhaustive or limit the disclosure to the precise forms disclosed in the following detailed description. Rather, the embodiments are chosen and described so that others skilled in the art may utilize their teachings.

Shape memory is introduced when a strip is bent, wound, twisted or otherwise distorted so that it is no longer straight. Shape memory materials (SMMs) have the ability to recover their original shape from a significant and seemingly plastic deformation. Several applications of shape memory are envisioned such as a strip comprised of SMMs with straight shape memory or a strip with no non-straight shape memory. Additional applications are also envisioned without shape memory materials such as a strip that is straight enough to reduce fabric shadowing or a strip comprised of materials with substantially no shape memory.

One functionality of a strip with no shape memory is that it is straight and will lie flat on a horizontal surface. When the strip is attached to fabric and suspended, the shape memory of the strip is transferred to the fabric.

When bias due to shape memory is introduced to the fabric, the fabric is perturbed from the vertical plane, deviates the fabric from planarity, and ripples, wrinkles and/or undulations are formed in the fabric. The ripples in the fabric refract light and create shadows on the surface.

Multiple strips are connected via joints. One form of joint is a tongue and grove joint. Tongue and groove is a method of fitting similar objects together, edge to edge. Tongue and groove joints allow two flat pieces to be joined strongly together to make a single flat surface. Other forms of joints include butt type joint, and butt type joints including a bar.

Multiple strips are connected in series. In one example, the tongue of the second strip fits into the grove of the first strip. In a second example, the tongue of the second strip fits into the grove of the first strip, and the tongue of the third strip fits into the grove of the second strip.

Two sheets of fabric, each sheet is comprised of alternating horizontal bands of fabric, where in the first fabric is sheer and the second fabric is non-transparent.

Sheer fabric permits light to transmit. Non-transparent fabric does not allow light to transmit.

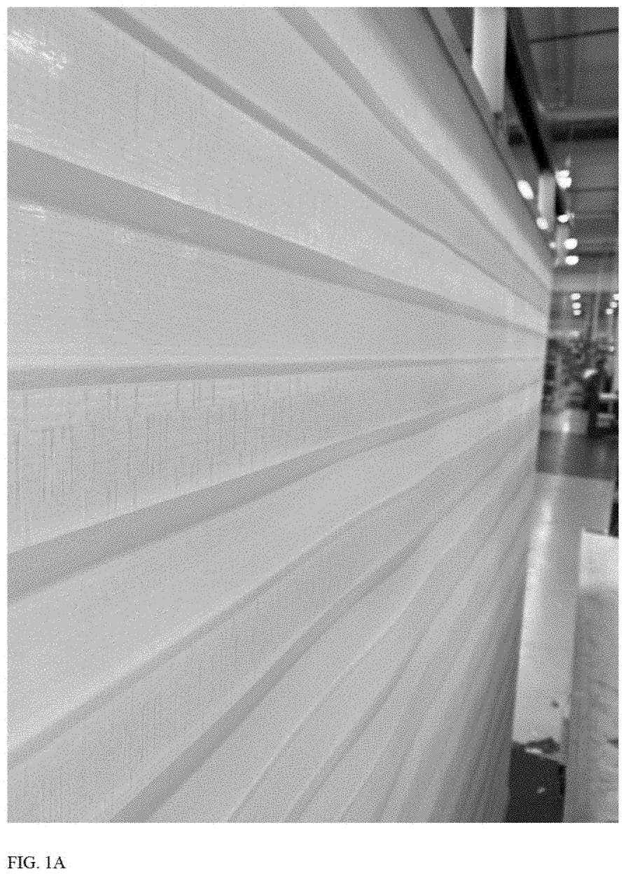

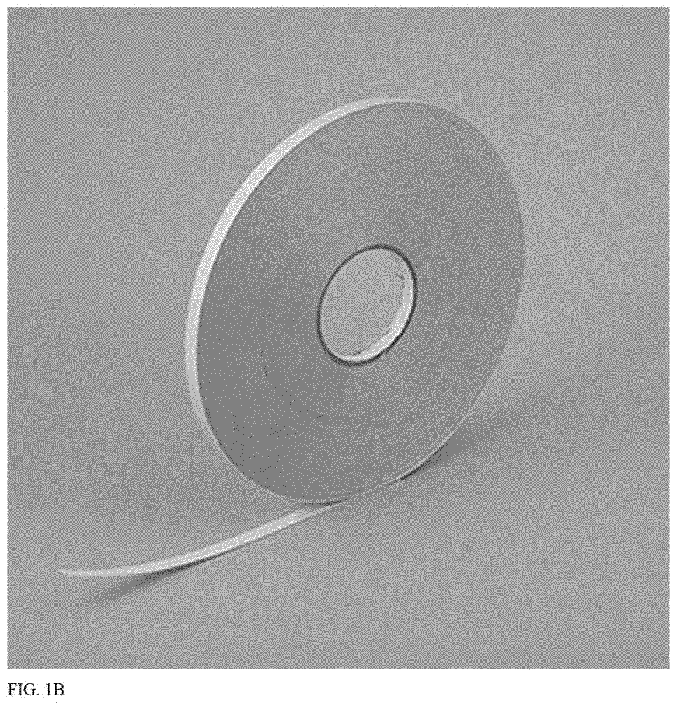

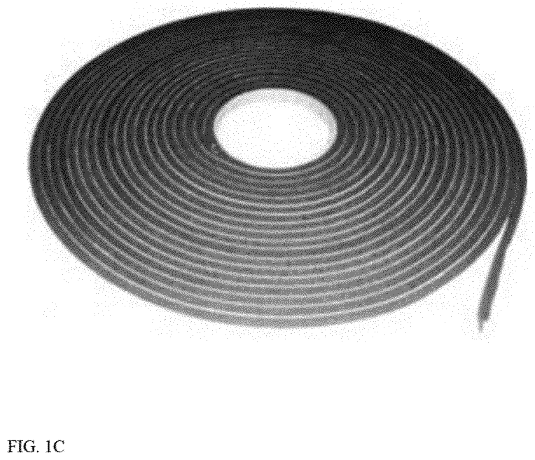

FIG. 1A shows the perspective view of the back of a typical zebra type roller blind shade assembly. The end of the fabric is attached to a strip located within a frame located near the top of the image. What is noticeable is the fabric undulating in a vertical fashion. FIG. 1B shows the shape memory of a typical strip on a spool. The shape memory is evidenced by how the typical strip of FIG. 1B rises from the flat surface instead of remaining straight.

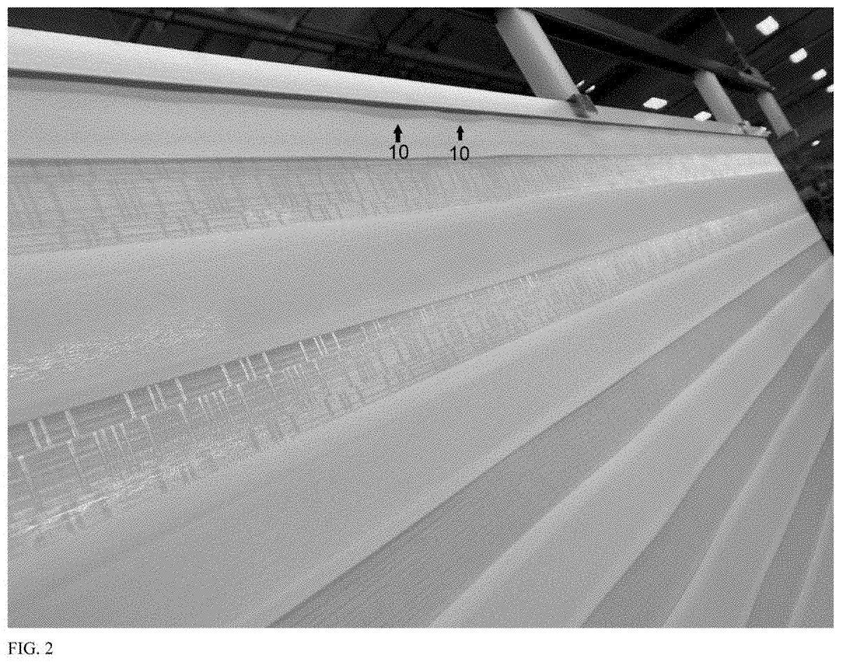

FIG. 2 shows a perspective view of the back of a typical zebra type roller blind shade assembly. What is noticeable is the fabric undulating in a vertical fashion as evidenced by the undulating shadow 10 of the frame on the fabric.

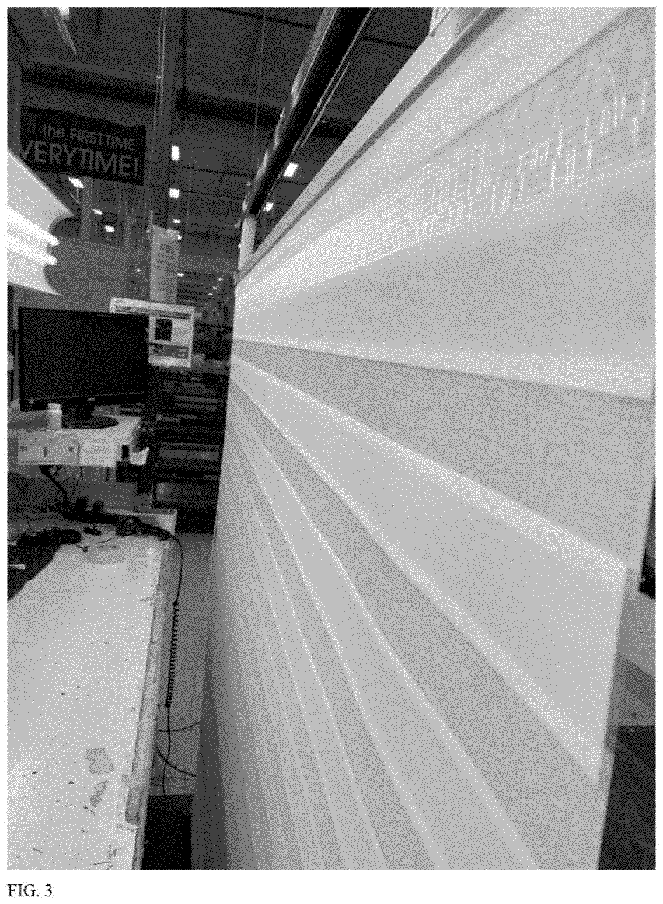

FIG. 3 shows a perspective view of the back of a zebra type roller blind shade according to an embodiment of the present disclosure that includes a strip that is straight enough to reduce fabric shadowing, wherein the strip with no shape memory. What is noticeable is the fabric has less undulating in a vertical fashion than the fabric shown in FIG. 1.

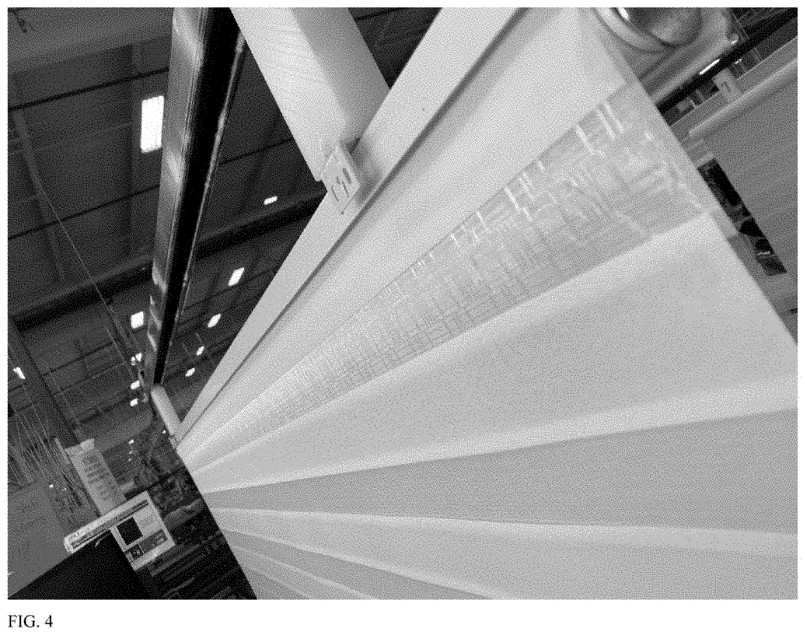

FIG. 4 shows a perspective view of the back of a zebra type roller blind shade according to an embodiment of the present disclosure that includes the strip with no shape memory. What is noticeable is the fabric has less undulation in a vertical fashion as evidenced by the less undulation in the shadow of the frame on the fabric than the fabric shown in FIG. 1.

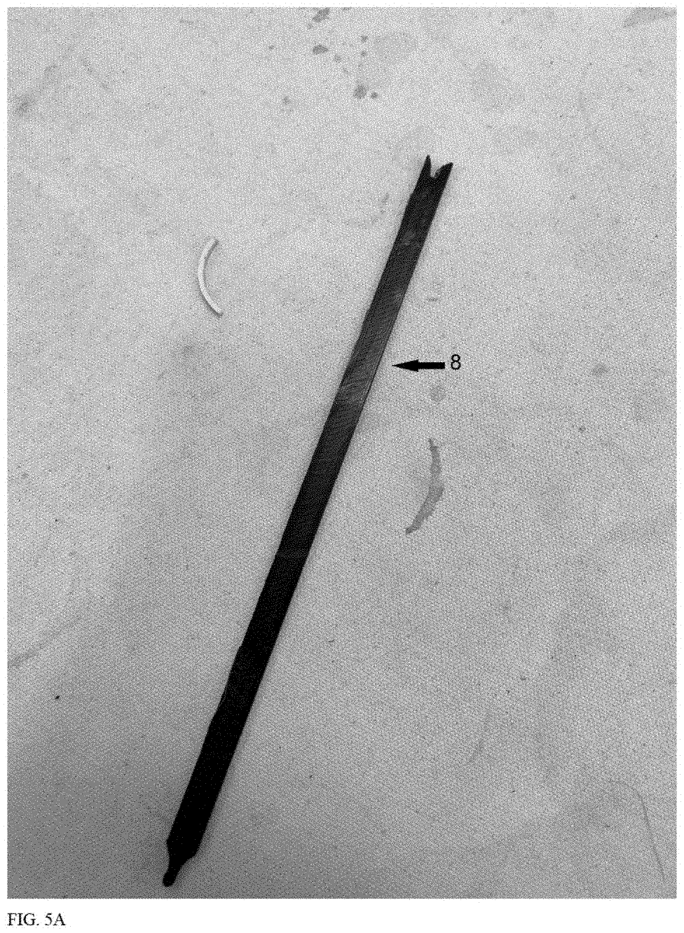

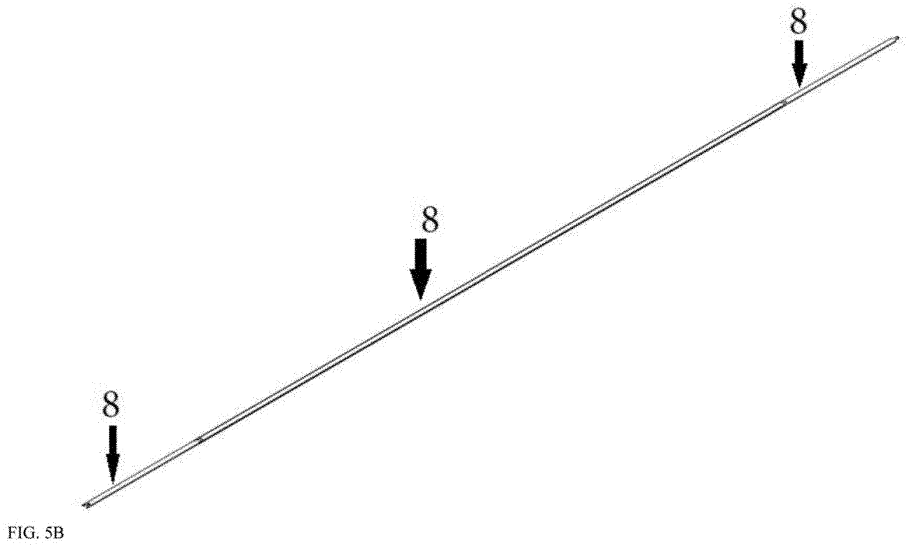

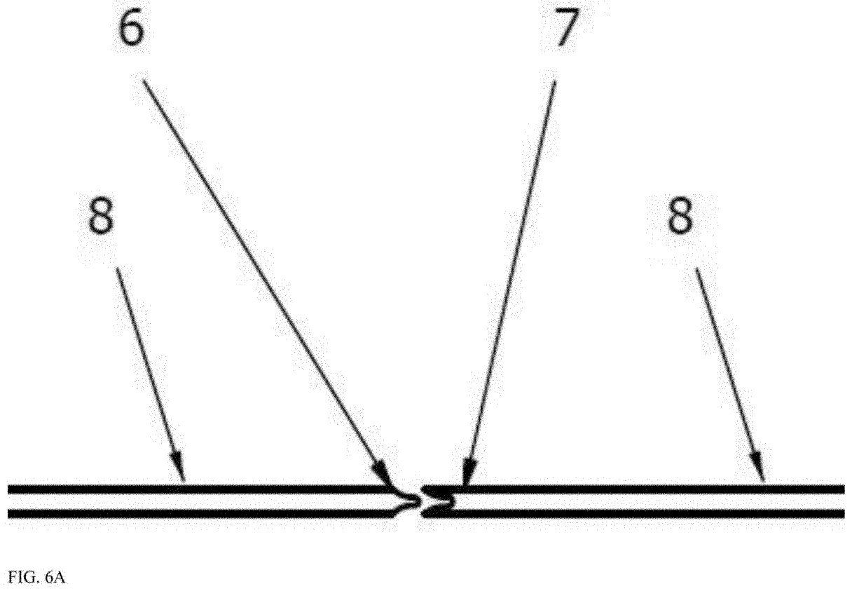

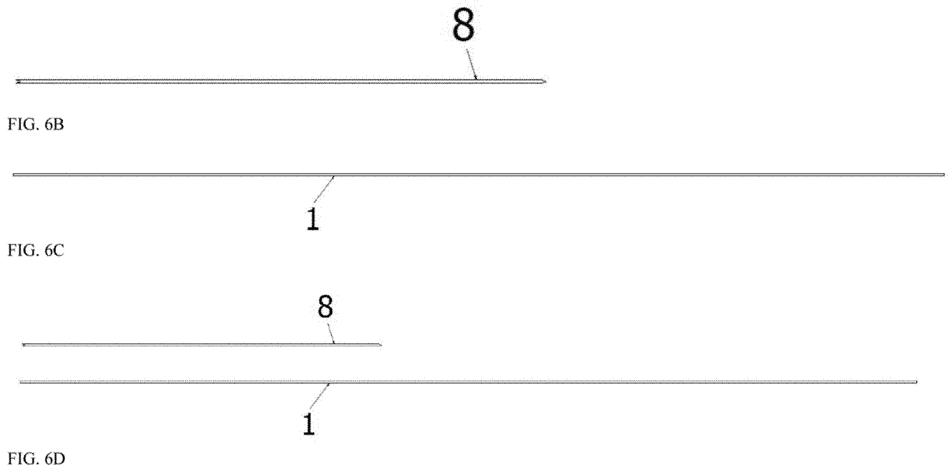

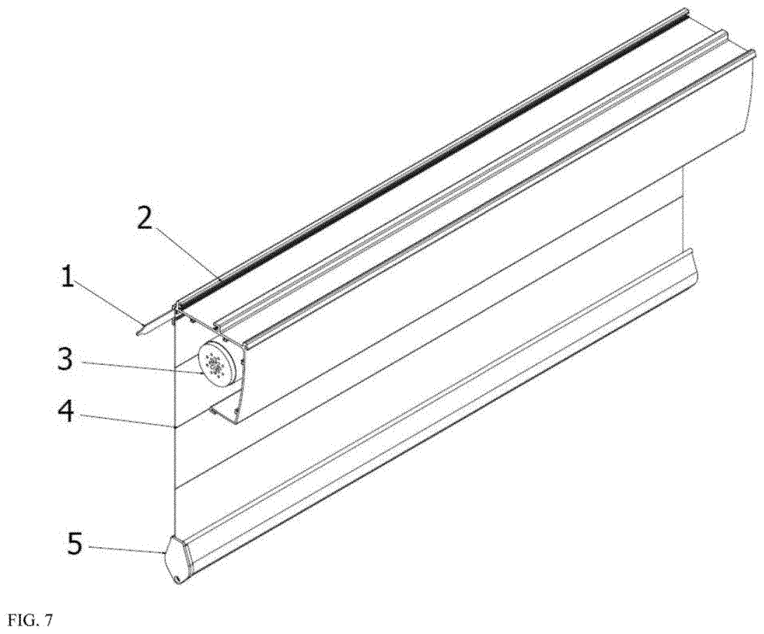

FIG. 5A is an individual strip 8 used in a shade assembly according to an embodiment of the present disclosure. Each end of the strip 8 is shaped for connecting to another strip 8. As best illustrated in FIG. 5B, multiple strips 8 may be connected via joints. One form of joint is illustrated in FIG. 6A as a tongue 6 and grove 7 joint.

FIGS. 6A-6C show a series of connected individual strips used in the shade assembly according to an embodiment of the present disclosure. As best illustrated in FIG. 6A, tongue 6 and groove 7 are complimentary in shape and fit together in series to form a continuous flat surface.

Multiple strips 8 of differing lengths (see FIG. 5B) are connected in series. The ‘no shape memory’ functionality of multiple strips 8 connected in series (FIG. 6B) is the same as an individual strip 1 with no shape memory (FIG. 6C). As shown in FIG. 6D, multiple strips 8 may be manufactured, stored, packaged, shipped straight since each strip is shorter.

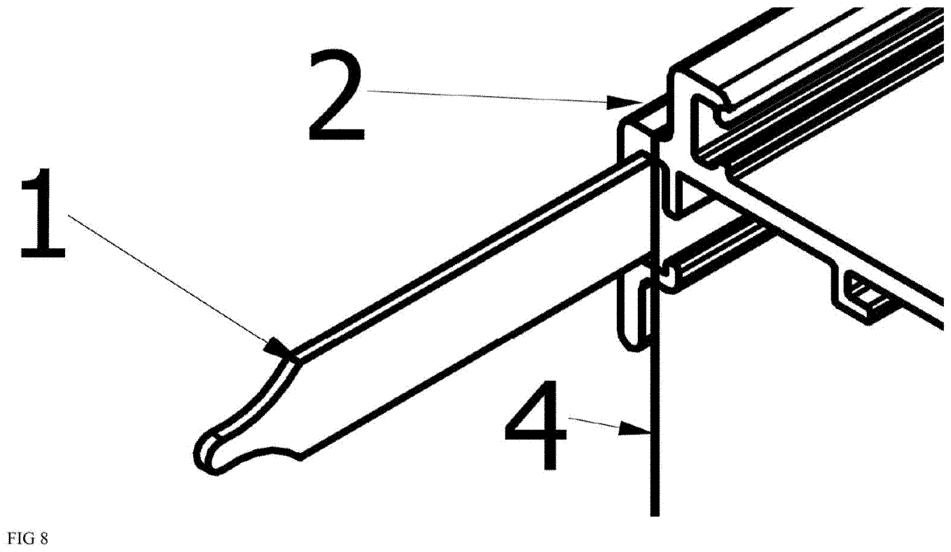

FIG. 7 shows the zebra type roller blind shade assembly according to an embodiment of the present disclosure that includes the strip according to an embodiment of the present disclosure. A zebra type roller shade assembly comprises at least one strip 1, a frame 2, and a roller 3, wherein the at least one strip 1 does not have shape memory, fabric 4, wherein the fabric is connected to moveable lower frame 5.

FIG. 8 shows a close up view of the zebra type roller blind shade assembly according to an embodiment of the present disclosure that includes the strip with no shape memory. Fabric 4 is glued, stitched or otherwise attached, to strip 1. Strip 1 with attached fabric 4 is inserted horizontally into frame 2.

Experimental Results

Two groups of three sets of shades that are 48″×36″ inside mount zebra shades were constructed. The first group utilized a standard rolled sizing strip with shape memory. The second group utilized a lineal sizing strip with no shape memory.

The three sets of shades included a sheer material, a room darkening (also known as a privacy or blackout) material, and a material in between sheer and room darkening. The tested sheer material is a product by the name of Covert Flannel. The tested room darkening material is a product by the name of Mirage Ice. The tested material in between sheer and room darkening is a product by the name of Mystic Canyon.

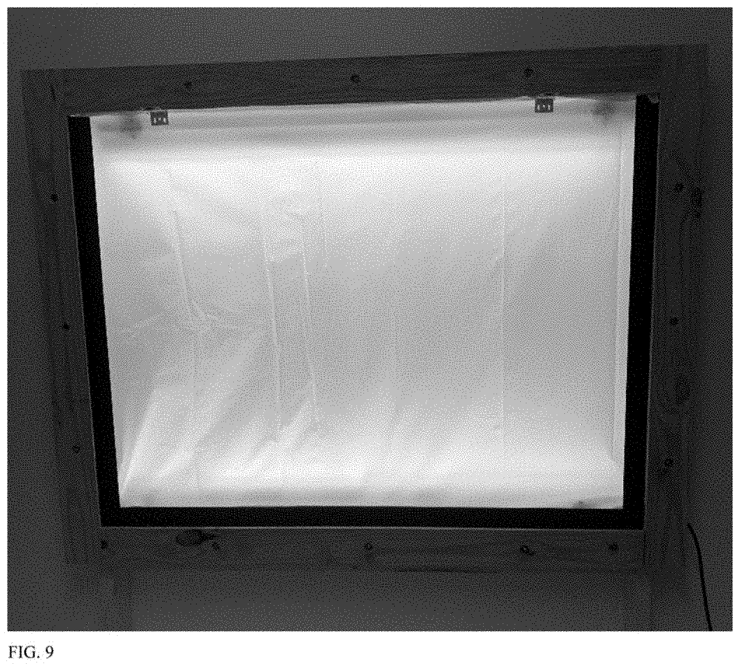

As illustrated in FIG. 9, two LED lights with a plastic covering were positioned on a wall in a dark room. The LED arrangement was set behind each of the shades to create a simulation of sunlight coming through the window. Each arrangement was created in a dark room to minimize ambient light.

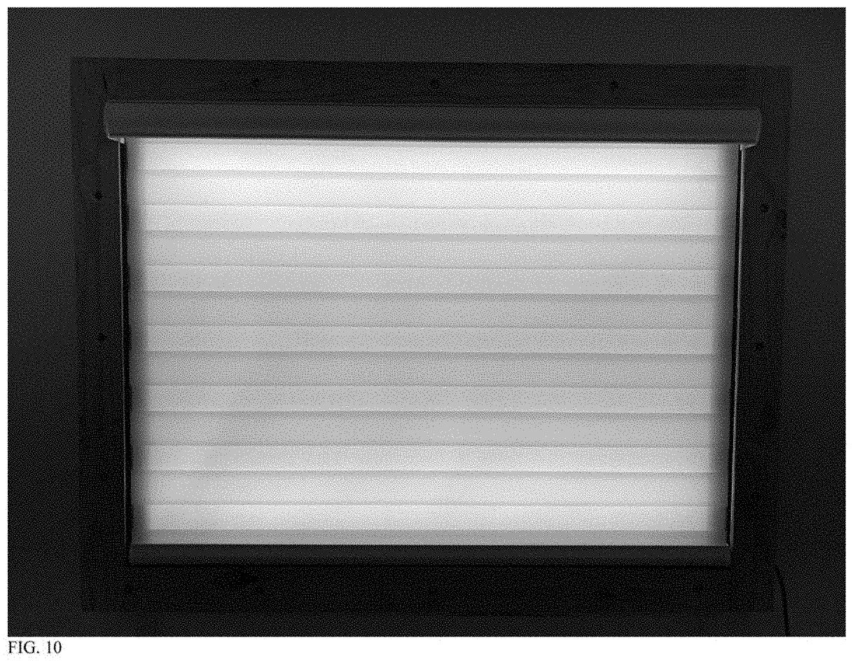

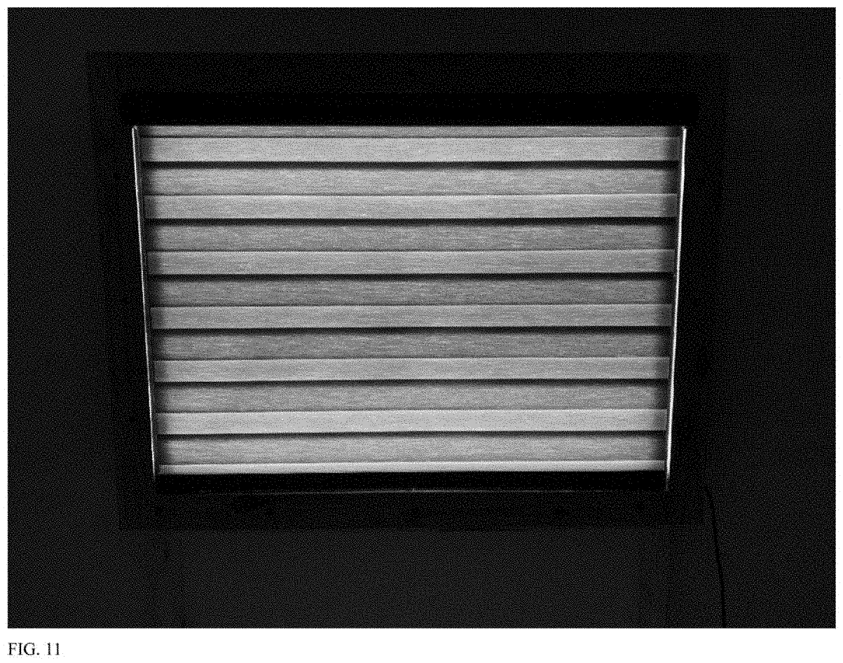

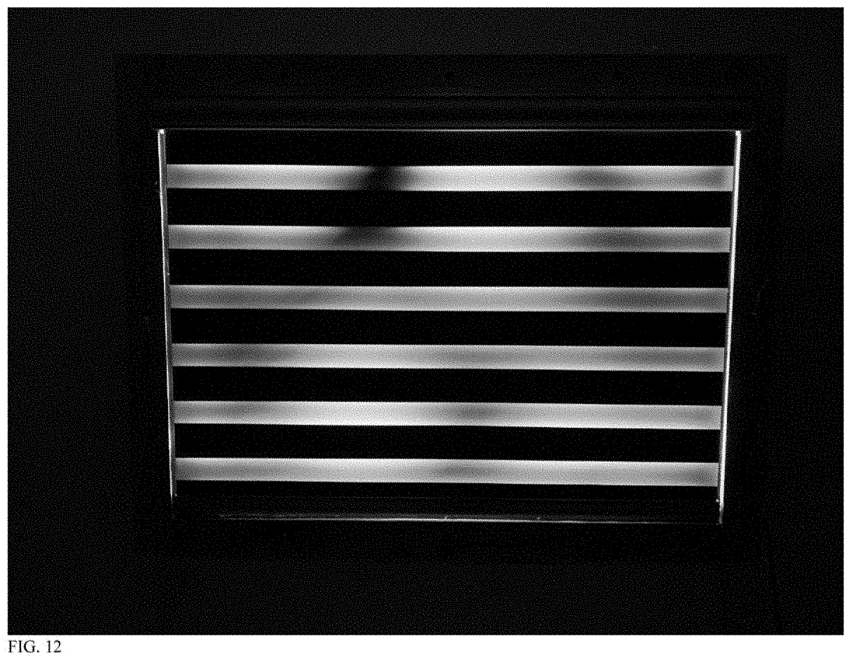

A light meter was placed 4 feet directly in front of the shade with the shade fully lowered to collect each of five readings. Table 1 below and FIGS. 10-12 summarize the findings:

| | | Reading (LUX) | | | | | | |
|---|---|---|---|---|---|---|---|---|
| Material | Sample | 1 | 2 | 3 | 4 | 5 | Average | % Difference |
| Mirage | Old Sizing Strip | 505 | 515 | 516 | 507 | 511 | 510.75 | 1.78% |
| Ice | New Sizing Strip | 510 | 507 | 491 | 499 | 506 | 501.75 | |
| Covert | Old Sizing Strip | 1.7 | 1.6 | 1.7 | 1.7 | 1.8 | 1.7 | 67.72% |
| Flannel | New Sizing Strip | 0.9 | 0.9 | 0.8 | 0.8 | 0.8 | 0.84 | |
| Mystic | Old Sizing Strip | 9.5 | 9.3 | 9.5 | 9.5 | 9.6 | 9.45 | 4.32% |
| Canyon | New Sizing Strip | 9.2 | 8.9 | 9 | 9.1 | 9.1 | 9.05 | |

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed is:

1. A blind assembly comprising:
a frame,
a roller supported by the frame,
a fabric suspended from the roller,
a strip located within the frame and wherein an end of the fabric is attached to the strip,
wherein the strip is comprised of materials with straight shape memory,
the strip is comprised of materials with substantially no shape memory,
the strip is straight enough to reduce fabric shadowing or wherein the strip does not have non-straight shape memory.

2. The blind assembly of claim 1, wherein the strip is comprised of multiple strips connected in series.

3. The blind assembly of claim 2, wherein multiple strips are connected via joints.

4. The blind assembly of claim 3, wherein in the joints are selected from the group comprising a tongue and grove, butt type joint, and butt type joints including a bar.

5. The blind assembly of claim 1, wherein the strip is comprised of materials that are not subject to shape memory.

6. The blind assembly of claim 1, wherein the strip has not been bent, folded, or distorted or the strip has been subjected to use of force or energy to minimize the shape memory.

7. The blind assembly of claim 1, wherein the roller is a zebra type roller shade.

8. The blind assembly of claim 1,
wherein the zebra type roller shade is comprised of two sheets of fabric, wherein each sheet is comprised of alternating horizontal bands of fabric, where in the first fabric is sheer and the second fabric is non-transparent.

9. The blind assembly of claim 1, further comprising:
a moveable lower frame supported by the fabric.

10. A method of assembling a blind assembly comprising the steps of:
(i) attaching an end of the fabric to the strip, and
(ii) inserting the strip with attached fabric into the frame, wherein the strip is straight enough to reduce fabric shadowing or wherein the strip does not have shape memory.

11. The method of assembling a blind assembly of claim 10, further comprising the step of:
connecting at least two shorter strips together to form the strip.

12. The method of assembling a blind assembly of claim 9, wherein the step of connecting at least two strips together includes connecting the strips in series.

13. The method of assembling a blind assembly of claim 9,
subjecting the strip to force or energy to minimize shape memory.

14. The method of assembling a blind assembly of claim 10, further comprising the steps:
(iii) attaching the fabric to the roller,
(iv) winding the fabric around the roller,
(v) inserting the roller with the frame,
(vi) attaching the fabric to moveable lower frame.
